(19) United States
(12) Patent Application Publication
(10) Pub. No.: US 2005/0212778 A1
(43) Pub. Date: Sep. 29, 2005

(54) Button device for a touch panel

(76) Inventor: Chun-Lin Yeh, Miaoli Hsien (TW)

Correspondence Address: Rabin & Berdo, P.C.;Suite 500, 1101 14th Street, Washington, DC, 20005, US

(21) Appl. No.: 11/088,859

(22) Filed: Mar. 25, 2005

(30) Foreign Application Priority Data
Mar. 29, 2004 (TW) 093108488

(51) Int. Cl. G09G 5/00

(52) U.S. Cl. 345/175

(57) ABSTRACT

A button device for a touch panel has a touch panel, an upper indium-tin oxide (ITO) layer, a light transmission board, a lower ITO layer, a spacer, multiple contacts, a reflective film and a light emitting diode (LED). The upper ITO layer is attached to the touch panel. The lower ITO layer is attached to the light transmission board. The spacer is attached to and between the upper and lower ITO layers. The contacts are mounted on the lower ITO layer and selectively electrically connect to the upper ITO layer. The reflective film is attached to the light transmission board and has a front edge, a rear edge and a primary rib formed near the front edge. The LED corresponds to the rear edge of the reflective film and emits light. The light is reflected by the reflective film out of the touch panel.

### BACKGROUND OF THE INVENTION

1. Field of the Invention

The present invention relates to a button device, especially to a button device for a touch panel.

2. Description of the Prior Arts

A button device is a necessary part of mobile phones and personal digital assistants (PDAs). With reference to FIG. 4 and 5, a conventional button device comprises a light transmission board (50), a rubber button assembly (51), an optional diffuser layer (511), a circuit board (52) and multiple light-emitting diodes (LEDs) (53). The light transmission board (50) absorbs light from a light source, transmits light from all surfaces and has a top surface and a bottom surface. The rubber button assembly (51) is attached to the top surface of the light transmission board (50). The diffuser layer (511) is a metal or a non-metal and is plated on the rubber button assembly (51). The LEDs (53) are mounted on the circuit board (52) and face the bottom surface of the light transmission board (50). When the rubber button assembly (51) is pressed, the LEDs (53) emit light, and the light transmission board (50) transmits the light to the rubber button assembly (51). However, the current trend is toward thin mobile phones and PDAs, and the conventional button device is thick. Furthermore, the conventional button device costs more money and uses more electricity, and the intensity of the light emitted from the button device is not uniform because multiple discrete LEDs (53) generate individual bright spots. Even though the diffusion layer (511) diffuses the light and makes the intensity of the light generally uniform, the diffusion layer (511) is not easy to manufacture and is harmful to the environment.

With reference to FIG. 3, another conventional button device comprises a liquid crystal display (LCD) panel (66), a light transmission board (60), a lower indium-tin oxide (ITO) layer (61), an upper ITO layer (63), a spacer (64), multiple contacts (65) and a touch panel (62). The light transmission board (60) is attached to the LCD panel (66). The lower ITO layer (61).is attached to the light transmission board (60) and has an edge. The upper ITO layer (63) has an edge. The spacer (64) is attached to and between the edges of the lower and upper ITO layers (61, 63). The contacts (65) are mounted separately on the lower ITO layer (61). The touch panel (62) is attached to the upper ITO layer (63). When the touch panel (62) is pressed, the upper ITO layer (63) presses against a contact (65) and connects to the lower ITO layer (61), and the LCD panel (66) emits light. The light transmission board (60) transmits the light emitted from the LCD panel (66) through the touch panel (62). However, using the LCD panel (66) is expensive.

To overcome the shortcomings, the present invention provides a button device for a touch panel to mitigate or obviate the aforementioned problems.

### SUMMARY OF THE INVENTION

The main objective of the present invention is to provide a button device for a touch panel that costs less, is thin and is not harmful to the environment. The button device for a touch panel has a touch panel, an upper indium-tin oxide (ITO) layer, a light transmission board, a lower ITO layer, a spacer, multiple contacts, a reflective film and a light emitting diode (LED). The upper ITO layer is attached to the touch panel. The lower ITO layer is attached to the light transmission board. The spacer is attached to and between the upper and lower ITO layers. The contacts are mounted on the lower ITO layer and selectively electrically connect to the upper ITO layer. The reflective film is attached to the light transmission board and has a front edge, a rear edge and a primary rib formed near the front edge. The LED corresponds to the rear edge of the reflective film and emits light. The light is reflected by the reflective film through the light transmission board out of the touch panel.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a button device for a touch panel in accordance with the present invention;

FIG. 2 is an enlarged side view of the front edge of the reflective film in the button device in FIG. 1;

FIG. 3 is a side view of an embodiment of a conventional button device in accordance with the prior art;

FIG. 4 is a side view of another embodiment of a conventional button device in accordance with the prior art; and

FIG. 5 is a side view of another embodiment of a conventional button device in accordance with the prior art.

### DETAILED DESCRIPTION OF THE PREFERRED EMBODIMENTS

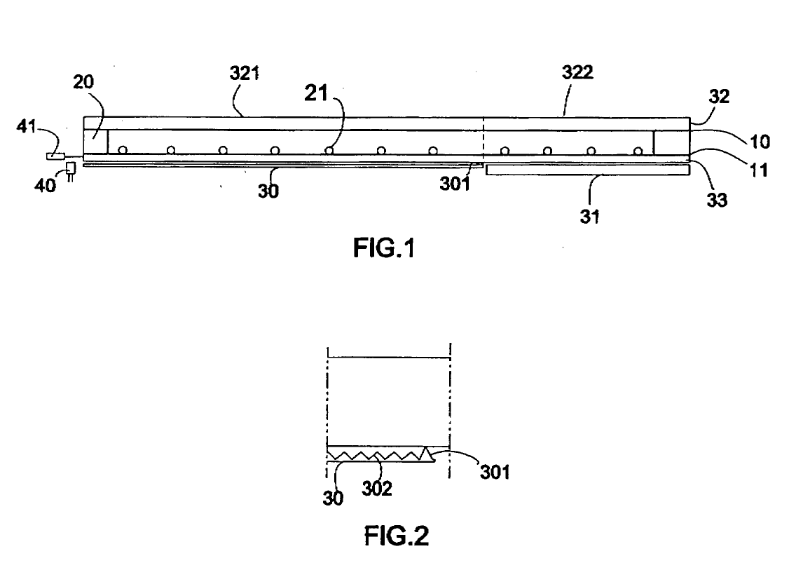

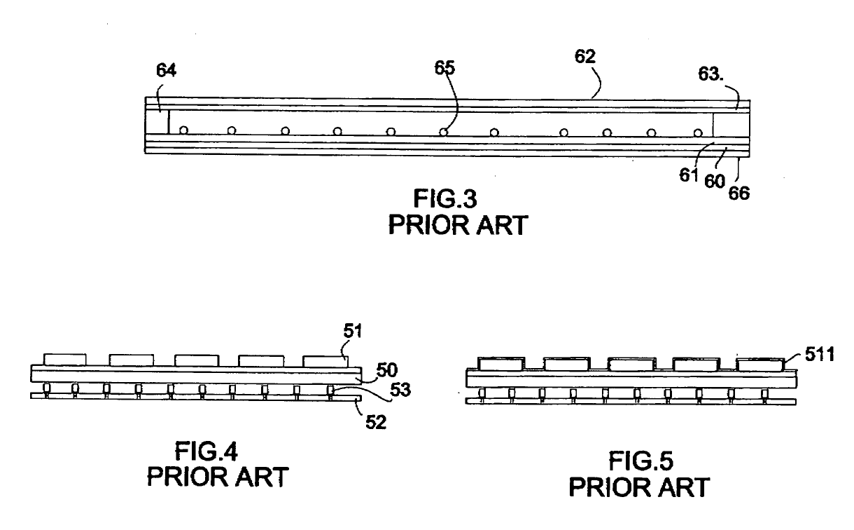

With reference to FIG. 1, a button device for a touch panel in accordance with the present invention comprises a touch panel (32), an upper indium-tin oxide (ITO) layer (10), a light transmission board (33), a lower ITO layer (11), a spacer (20), multiple contacts (21), a reflective film (30), a light emitting diode (LED) (40) and a wire (41).

The touch panel (32) has a top surface, a bottom surface, a button section (321) and a display section (322).

The upper ITO layer (10) is attached to the bottom surface of the touch panel (32) and has an edge.

The light transmission board (33) has a top surface and a bottom surface.

The lower ITO layer (11) is attached to the top surface of the light transmission board (33) and has an edge.

The spacer (20) is attached to and between the edges of the upper and lower ITO layers (10, 11).

The contacts (21) are mounted separately on the lower ITO layer (11).

With further reference to FIG. 2, the reflective film (30) is attached to the bottom surface of the light transmission board (33), corresponds to the button section (321) of the touch panel (32) and has a top surface, a front edge, a rear edge, a primary rib (301) and multiple optional secondary ribs (302). The primary rib (301) is formed on the top surface of the reflective film (30) near the front edge. The secondary ribs (302) are formed on the entire top surface, are shorter than the primary rib (301) and may have a sharp, blunt or rounded edge.

The LED (40) corresponds to the rear edge of the reflective film (30). The wire (41) is mounted on the light transmission board (41), corresponds to the rear edge of the reflective film (30) and electrically connects to the lower ITO layer (11).

A liquid crystal display (LCD) panel (31) is attached to the bottom surface of the light transmission board (33) and corresponds to the display section (322) of the touch panel (32).

When the button section (321) of the touch panel (32) is pressed, the upper ITO layer (10) is pressed down and connects to a corresponding contact (21), which electrically connects the upper ITO layer (10) to the lower ITO layer (11). Signals transmit through the upper ITO layer (10), the contacts (21) and the lower ITO layer (11) to the wire (41). The wire (41) transmits the signals to a control circuit. The control circuit causes the LED (40) to emit light. The reflective film (30) reflects the light through the light transmission board (33) through the touch panel (32). The primary rib (301) blocks the reflected light to keep the reflected light from washing out the LCD (31).

The button device for a touch panel as described has numerous advantages. The button device costs less because the button device only has one LED (40) with the reflective film (30) reflecting the light of the LED (40). The button device is thin because the button device has the reflective film (30) to reflect light. The components of the button device are all recyclable and are not harmful to the environment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A button device for a touch panel comprising
a touch panel having a top surface, a bottom surface, a button section and a display section;
an upper indium-tin oxide (ITO) layer attached to the bottom surface of the touch panel and having an edge;
a light transmission board having a top surface and a bottom surface;
a lower ITO layer attached to the top surface of the light transmission board and having an edge;
a spacer attached to and between the edges of the upper and lower ITO layers;
multiple contacts mounted separately on the lower ITO layer;
a reflective film attached to the bottom surface of the light transmission board, corresponding to the button section of the touch panel and having
a top surface;
a front edge;
a rear edge; and
a primary rib formed on the top surface of the reflective film near the front edge;
a light emitting diode corresponding to the rear edge of the reflective film; and
a wire mounted on the light transmission board, corresponding to the rear edge of the reflective film and electrically connecting to the lower ITO layer.

2. The button device as claimed in claim 1, wherein the reflective film further has multiple secondary ribs formed on the entire top surface of the reflective film and being shorter than the primary rib.

3. The button device as claimed in claim 2, wherein each rib has a sharp edge.
